(19) United States
(12) Patent Application Publication
(10) Pub. No.: US 2009/0018842 A1
(43) Pub. Date: Jan. 15, 2009

(54) AUTOMATED SPEECH RECOGNITION (ASR) CONTEXT

(75) Inventors: Jacob W. Caire, Olathe, KS (US); Pascal M. Lutz, Leawood, KS (US); Kenneth A. Bolton, Olathe, KS (US)

Correspondence Address: GARMIN LTD.;C/O GARMIN INTERNATIONAL, INC., ATTN: Legal - IP, 1200 EAST 151ST STREET, OLATHE, KS, 66062, US

(73) Assignee: GARMIN LTD., George Town, KY (US)

(21) Appl. No.: 11/960,423

(22) Filed: Dec. 19, 2007

Related U.S. Application Data
(60) Provisional application No. 60/949,140, filed on Jul. 11, 2007.
(60) Provisional application No. 60/949,151, filed on Jul. 11, 2007.

(51) Int. Cl. G10L 15/00

(52) U.S. Cl. 704/277; 704/E15.003

(57) ABSTRACT

Techniques are described to create a context for use in automated speech recognition. In an implementation, a determination is made as to which data received by a position-determining device is selectable to initiate one or more functions of the position-determining device, wherein at least one of the functions relates to position-determining functionality. A dynamic context is generated to include one or more phrases taken from the data based on the determination. An audio input is translated by the position-determining device using one or more said phrases from the dynamic context.

### RELATED APPLICATIONS

The present non-provisional application claims the benefit of U.S. Provisional Application No. 60/949,140, entitled “AUTOMATED SPEECH RECOGNITION (ASR) CONTENT,” filed Jul. 11, 2007, and U.S. Provisional Application No. 60/949,151, entitled “AUTOMATED SPEECH RECOGNITION (ASR) LISTS,” filed Jul. 11, 2007. Each of the above-identified applications are incorporated herein by reference in their entirety.

### BACKGROUND

Automatic speech recognition (ASR) is typically employed to translated speech to find “meaning”, which may then be used to perform a desired function. Traditional techniques that were employed to provide ASR, however, consumed a significant amount of resources (e.g., processing and memory resources) and therefore could be expensive to implement. Further, this implementation may be further complicated when confronted with a large amount of data which may cause an increase in latency when performing ASR as well as a decrease in accuracy. One implementation where the large amount of data may be encountered is in devices having position-determining functionality.

For example, positioning systems (e.g., the global positioning system (GPS)) may employ a large amount of data to provide position-determining functionality, such as to provide turn-by-turn driving instructions to a point-of interest. These points-of-interest (and the related data) may consume a vast amount of resources and consequently cause a delay when performing ASR, such as to locate a particular point-of-interest. Further, the accuracy of ASR may decrease when an increased number of options become available for translation of an audio input, such as due to similar sounding points-of-interest.

### SUMMARY

Techniques are described to create a dynamic context for use in automated speech recognition. In an implementation, a determination is made as to which data received by a position-determining device is selectable to initiate one or more functions of the position-determining device, wherein at least one of the functions relates to position-determining functionality. A dynamic context is generated to include one or more phrases taken from the data based on the determination. An audio input is translated by the position-determining device using one or more said phrases from the dynamic context.

This Summary is provided solely to introduce subject matter that is fully described in the Detailed Description and Drawings. Accordingly, the Summary should not be considered to describe essential features nor be used to determine scope of the claims.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an exemplary positioning system environment that is operable to perform automated speech recognition (ASR) context techniques.

FIG. 2 is an illustration of a system in an exemplary implementation showing the position-determining device of FIG. 1 in greater detail as employing an ASR technique that uses a context.

FIG. 3 is a flow diagram depicting a procedure in an exemplary implementation in which a context is generated based on phrases currently displayed in a user interface and is maintained dynamically to reflect changes to the user interface.

FIG. 4 is a flow diagram depicting a procedure in an exemplary implementation in which phrases are imported by a device from another device to provide a context to ASR to be used during interaction between the devices.

### DETAILED DESCRIPTION

Traditional techniques that were employed to provide automated speech recognition (ASR) typically consumed a significant amount of resources (e.g., processing and memory resources). Further, implementation of ASR may be further complicated when confronted with a large amount of data, such as an amount of data that may be encountered in a device having music playing functionality (e.g., a portable music player having thousands of songs with associated metadata that includes title, artists, and so on), address functionality (e.g., a wireless phone having an extensive phonebook), positioning functionality (e.g., a positioning database containing points of interest, addresses and phone numbers), and so forth.

For example, a personal Global Positioning System (GPS) device may be configured for portable use and therefore have relatively limited resources (e.g., processing resources) when compared to devices that are not configured for portable use, such as a server or a desktop computer. The personal GPS device, however, may include a significant amount of data that is used to determine a geographic position and to provide additional functionality based on the determined geographic position. For instance, a user may speak a name of a desired restaurant. In response, the personal GPS device may convert the spoken name to find “meaning”, which may consume a significant amount of resources. The personal GPS device may also determine a current geographic location and then use this location to search data to locate a nearest restaurant with that name or a similar name, which may also consume a significant amount of resources.

Accordingly, techniques are described that provide a dynamic context for use in automated speech recognition (ASR), which may be used to improve efficiency and accuracy in ASR. In an implementation, a dynamic context is created of phrases that are selectable to initiate a function of the device. For example, the context may be configured to include phrases that are selectable by a user to initiate a function of the device. Therefore, this context may be used with ASR to more quickly locate those phrases, thereby reducing latency when performing ASR (e.g., by analyzing a lesser amount of data) and improving accuracy (e.g., by lowering a number of available options and therefore possibilities of having similar sounding phrases). A variety of other examples are also contemplated, further discussion of which may be found in relation to the following figures.

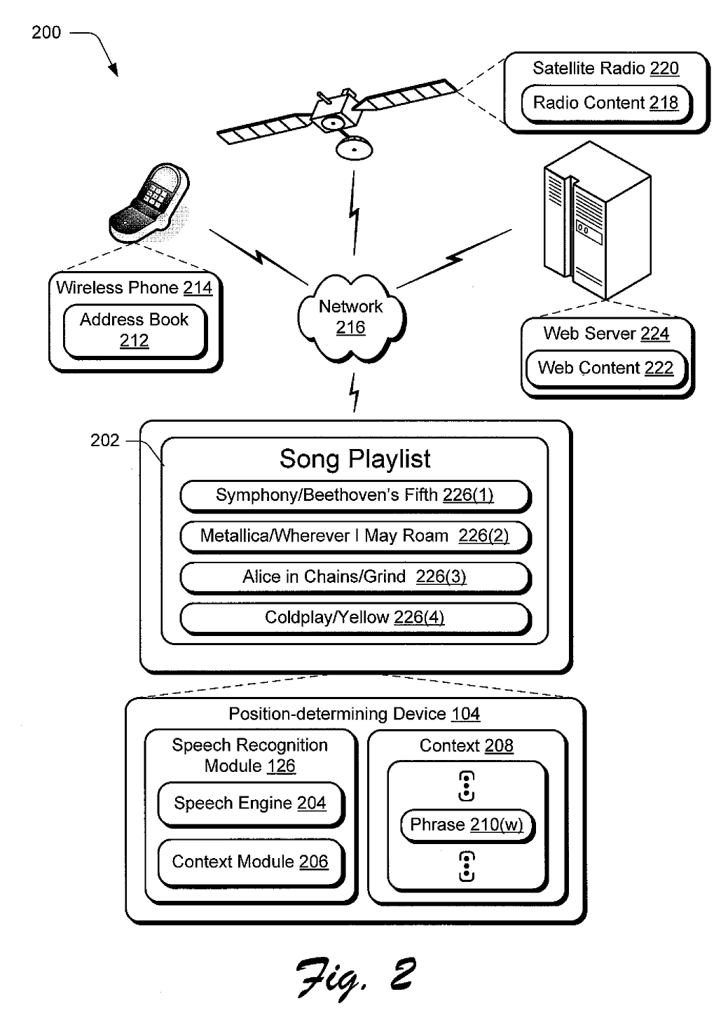

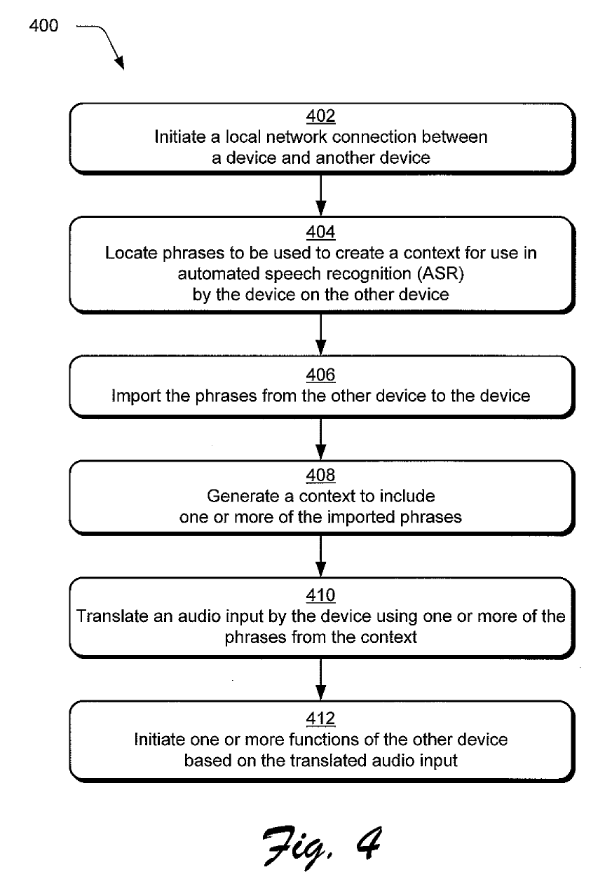

In another implementation, the context is defined at least in part by data obtained from another device over a local network connection. Continuing with the previous example, a user may employ a personal GPS device to utilize navigation functionality. The GPS device may also include functionality to initiate functions of another device, such as to dial and communicate via a user's wireless phone using ASR over a local wireless connection. To provide a context for ASR in use of the wireless phone by the GPS device, the GPS device may obtain data from the wireless phone. For instance, the GPS device may import the address book and generate a context from phrases included in the address book. This context may then be used for ASR by the GPS device when interacting with the wireless phone. In this way, the data of the wireless phone may be leveraged by the GPS device to improve efficiency (e.g., reduce latency and use of processing and memory resources) and also improve accuracy. Further discussion of importation of data to generate a context from another device may be found in relation to FIGS. 2 and 4.

In the following discussion, an exemplary environment is first described that is operable to generate and utilize a context with automated speech recognition (ASR) techniques. Exemplary procedures are then described which may employed in the exemplary environment, as well as in other environments without departing from the spirit and scope thereof. Although the ASR context techniques are described in relation to a position-determining environment, it should be readily apparent that these techniques may be employed in a variety of environments, such as by portable music players, wireless phones, and so on to provide portable music play functionality, traffic awareness functionality (e.g., information relating to accidents and traffic flow used to generate a route), Internet search functionality, and so on.

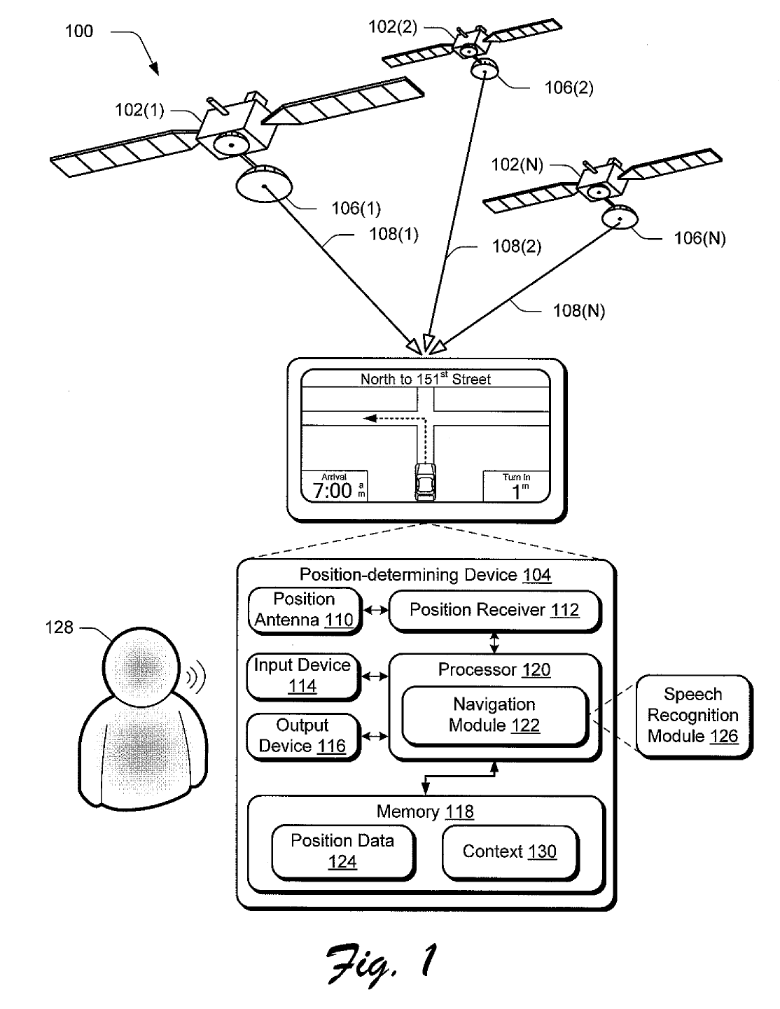

FIG. 1 illustrates an exemplary positioning system environment 100 that is operable to perform automated speech recognition (ASR) context techniques. A variety of positioning systems may be employed to provide position-determining techniques, an example of which is illustrated in FIG. 1 as a Global Positioning System (GPS). The environment 100 can include any number of position-transmitting platforms 102(1)-102(N), such as a GPS platform, a satellite, a retransmitting station, an aircraft, and/or any other type of positioning-system-enabled transmission device or system. The environment 100 also includes a position-determining device 104, such as any type of mobile ground-based, marine-based and/or airborne-based receiver, further discussion of which may be found later in the description. Although a GPS system is described and illustrated in relation to FIG. 1, it should be apparent that a wide variety of other positioning systems may also be employed, such as terrestrial based systems (e.g., wireless-phone based systems that broadcast position data from cellular towers), wireless networks that transmit positioning signals, and so on. For example, positioning-determining functionality may be implemented through use of a server in a server-based architecture, from a ground-based infrastructure, through one or more sensors (e.g., gyros, odometers, magnetometers), use of “dead reckoning” techniques, and so on.

In the environment 100 of FIG. 1, the position-transmitting platforms 102(1)-102(N) are depicted as GPS satellites which are illustrated as including one or more respective antennas 106(1)-106(N). The one or more antennas 106(1)-106(N) each transmit respective signals 108(1)-108(N) that may include positioning information and navigation signals to the position-determining device 104. Although three position-transmitting platforms 102(1)-102(N) are illustrated, it should be readily apparent that the environment may include additional position-transmitting platforms 102(1)-102(N) to provide additional position-determining functionality, such as redundancy and so forth. For example, the three illustrated position-transmitting platforms 102(1)-102(N) may be used to provide two-dimensional navigation while four position-transmitting platforms may be used to provide three-dimensional navigation. A variety of other examples are also contemplated, including use of terrestrial-based transmitters as previously described.

Position-determining functionality, for purposes of the following discussion, may relate to a variety of different navigation techniques and other techniques that may be supported by “knowing” one or more positions. For instance, position-determining functionality may be employed to provide location information, timing information, speed information, and a variety of other navigation-related data. Accordingly, the position-determining device 104 may be configured in a variety of ways to perform a wide variety of functions. For example, the positioning-determining device 104 may be configured for vehicle navigation as illustrated, aerial navigation (e.g., for airplanes, helicopters), marine navigation, personal use (e.g., as a part of fitness-related equipment), and so forth. Accordingly, the position-determining device 104 may include a variety of devices to determine position using one or more of the techniques previously described.

The illustrated positioning-determining device 104 of FIG. 1 includes a position antenna 110 that is communicatively coupled to a position receiver 112. The position receiver 112, an input device 114 (e.g., a touch screen, buttons, microphone, wireless input device, data input, and so on), an output device 116 (e.g., a screen, speakers and/or data connection) and a memory 118 are also illustrated as being communicatively coupled to a processor 120.

The processor 120 is not limited by the materials from which it is formed or the processing mechanisms employed therein, and as such, may be implemented via semiconductor(s) and/or transistors (e.g., electronic integrated circuits (ICs)), and so forth. Additionally, although a single memory 118 is shown, a wide variety of types and combinations of memory may be employed, such as random access memory (RAM), hard disk memory, removable medium memory (e.g., the memory 118 may be implemented via a slot that accepts a removable memory cartridge), and other types of computer-readable media.

Although the components of the position-determining device 104 are illustrated separately, it should be apparent that these components may also be further divided (e.g., the output device 116 may be implemented as speakers and a display device) and/or combined (e.g., the input and output devices 114, 116 may be combined via a touch screen) without departing from the spirit and scope thereof.

The illustrated position antenna 110 and position receiver 112 are configured to receive the signals 108(1)-108(N) transmitted by the respective antennas 106(1)-106(N) of the respective position-transmitting platforms 102(1)-102(N). These signals are provided to the processor 120 for processing by a navigation module 122, which is illustrated as being executed on the processor 120 and is storable in the memory 118. The navigation module 122 is representative of functionality that determines a geographic location, such as by processing the signals 108(1)-108(N) obtained from the position-transmitting platforms 102(1)-102(N) to provide the position-determining functionality previously described, such as to determine location, speed, time, and so forth.

The navigation module 122, for instance, may be executed to use position data 124 stored in the memory 118 to generate navigation instructions (e.g., turn-by-turn instructions to an input destination), show a current position on a map, and so on. The navigation module 122 may also be executed to provide other position-determining functionality, such as to determine a current speed, calculate an arrival time, and so on. A wide variety of other examples are also contemplated.

The navigation module 122 is also illustrated as including a speech recognition module 126, which is representative of automated speech recognition (ASR) functionality that may be employed by the position-determining device 104. The speech recognition module 126, for instance, may include functionality to covert an audio input received from a user 128 via an input device 114 (e.g., a microphone, Bluetooth headset, and so on) to find “meaning”, such as text, a numerical representation, and so on. A variety of techniques may be employed to translate an audio input.

The speech recognition module 126 may also employ ASR context techniques to create a context 130 for use in ASR to increase accuracy and efficiency. The techniques, for example, may be employed to reduce an amount of data searched to perform ASR. By reducing the amount of data searched, an amount of resources employed to implement ASR may be reduced while increasing ASR accuracy, further discussion of which may be found in relation to the following figure.

FIG. 2 is an illustration of a system 200 in an exemplary implementation showing the position-determining device 104 of FIG. 1 in greater detail as outputting a user interface 202 and employing an ASR technique that uses a context. In the illustrated implementation, the speech recognition module 126 is illustrated as including a speech engine 204 and a context module 206. The speech engine 204 is representative of functionality to translate an audio input to find meaning. The context module 206 is representative of functionality to create a context 208 having one or more phrases 210(w) (where “w” can be any integer from one to “W”). The context 208, and more particularly the phrases 210(w) in the context 208, may then be used by the speech engine 204 to translate an audio input. The context 208 may be generated by the context module 206 in a variety of ways.

For example, the context module 206 may import an address book 212 from a wireless phone 214 via a network 216 configured to supply a local network connection, such as a local wireless connection implemented using radio frequencies. Therefore, when the position-determining device 104 interacts with the wireless phone 214, the address book 212 may be leveraged to provide a context 208 to that interaction by including phrases 210(w) that are likely to be used by the user 128 when interacting with the wireless phone 214. Although a wireless phone 214 has been described, a variety of device combinations may employ importation techniques to create a context for use in ASR, further discussion of which may be found in relation to FIG. 4.

In another example, the context module 206 may generate the context 208 to include phrases 210(w) based on what is currently displayed by the position-determining device. For instance, the position-determining device 104 may receive radio content 218 via satellite radio 220, web content 222 from a web server 224 via the network 216 when configured as the Internet, and so on. Therefore, the position-determining device 104 in this example may use the context module 206 to create a context 208 that also defines what interaction is available based on what is currently being displayed by the position-determining device 104. The context 208 may also reflect other functions that are not currently being displayed by are available for selection, such as for songs that are in a list to be scrolled, navigation functions that are accessible from multiple menus, and so on.

As illustrated in FIG. 2, the position-determining device 104 depicts a plurality of portions 226(1)-226(4) that are selectable in the user interface to initiate a function, which is depicted as artist/song title combinations that are selectable to cause a corresponding song to be output. The context module 206 may examine the user interface to locate phrases 210(w) included in the user interface and include them in the context 208. Therefore, this context 208 may be used by the speech engine 204 to enable the user 128 to speak one or more of the phrases 210(w) to cause initiation of a corresponding function. For example, the user 128 may speak the words “Beethoven's Fifth”, “Beethoven” and/or “Symphony” to cause selection of respective portion 226(1) as if a user manually interacted with the user interface, e.g., “pressed” the portion 226(1) using a finger.

In an implementation, the context module 206 is configured to maintain the context 208 dynamically to reflect changes made in the user interface. For example, another song may be made available via satellite radio 220 which causes a corresponding change in the user interface. Phrases from this new song may added to the context 208 to keep the context 208 “up-to-date”. Likewise, this other song may replace a previously displayed song in the user interface. Consequently, the context module 206 may remove phrases that correspond to the replaced song from the context 208. Further discussion of creation, use and maintenance of the context 208 may be found in relation to the following procedures.

Generally, any of the functions described herein can be implemented using software, firmware, hardware (e.g., fixed logic circuitry), manual processing, or a combination of these implementations. The terms “module” and “functionality” as used herein generally represent software, firmware, hardware or a combination thereof. In the case of a software implementation, for instance, the module represents executable instructions that perform specified tasks when executed on a processor, such as the processor 120 of the position-determining device 104 of FIG. 1. The program code can be stored in one or more computer readable media, an example of which is the memory 118 of the position-determining device 104 of FIG. 1. The features of the ASR context techniques described below are platform-independent, meaning that the techniques may be implemented on a variety of commercial computing platforms having a variety of processors.

The following discussion describes ASR context techniques that may be implemented utilizing the previously described systems and devices. Aspects of each of the procedures may be implemented in hardware, firmware, software or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and/or the system 200 of FIG. 2.

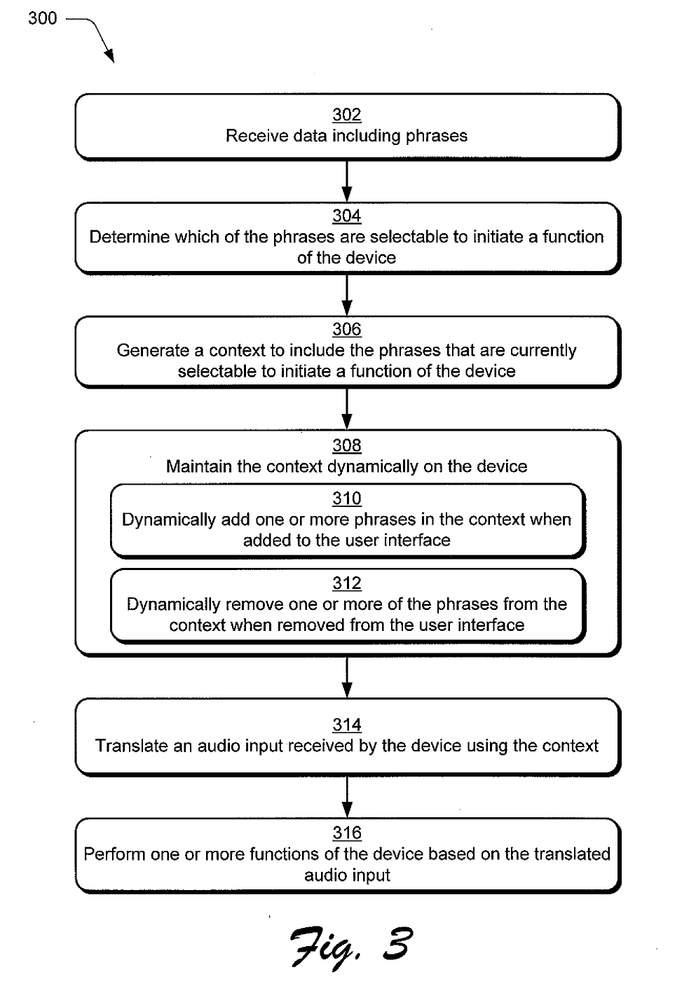

FIG. 3 depicts a procedure 300 in an exemplary implementation in which a context is generated based on phrases currently displayed in a user interface and is maintained dynamically to reflect changes to the user interface. Data is received that includes phrases (block 302). As previously described, this data may be received in a variety of ways, such as by importing data over a local network connection, metadata included in radio context streamed via satellite radio, web content obtained via the Internet, and so on.

A determination is made as to which of the phrases are selectable via the user interface to initiate a function of the device (block 304). For instance, the context module 206 may parse underlying code used to form the user interface to determine which functions are available via the user interface. The context module 206 may then determine from this code the phrases that are to be displayed in a user interface to represent this function and/or are otherwise selectable to initiate the function. For purposes of the following discussion, it should be noted that “phrases” are not limited to traditional spoken languages (e.g., traditional English words), but may include any combination of alphanumeric and symbolic characters which may be used to represent a function. In other words, a “phrase” may include a portion of a word, e.g., an “utterance”. Further, as should be readily apparent combinations of phrases are also contemplated, such as words, utterances and sentences.

A context is then generated to include the phrases that are currently selectable to initiate a function of the device (block 306). The context, for instance, may reference the phrases that are currently displayed which are selectable. In an implementation, the phrases included in the context may be filtered to remove phrases that are not uniquely identifiable to a particular function, such as “to”, “the”, “or”, and so on while leaving phrases such as “symphony”. In this way, the context may define options for selection by a user based on what is currently displayed, and may also include options that are not currently displayed but are selectable, such as a member of a list that is not currently displayed as previously described.

The context may also be maintained dynamically on the device (block 308). For example, one or more phrases may be dynamically added to the context when added to the user interface (block 310). Likewise, one or more of the phrases from the context are removed when removed from the user interface (block 312).

A device, for instance, may be configured to receive radio content 218 via satellite radio 220. Song names may be displayed in the user interface as shown in FIG. 2. As the song names change in the user interface, the phrases 210(w) in the context 208 may also be changed. Thus, the context module 206 may ensure that the phrases 210(w) included in the context 208 accurately reflect the phrases that are displayed in the user interface. A variety of other examples are also contemplated.

An audio input received by the device is then translated using the context (block 314) and one or more functions of the device are performed based on the translated audio input (block 316). Continuing with the previous instance, the audio input may cause a particular song to be output. A variety of other instances are also contemplated.

FIG. 4 depicts a procedure 400 in an exemplary implementation in which phrases are imported by a device from another device to provide a context to ASR to be used during interaction between the devices. A local network connection is initiated between a device and another device (block 402). For example, the position-determining device 104 may initiate a local wireless connection (e.g., Bluetooth) with the wireless phone 214 of FIG. 2.

Phrases to be used to create a context for use in automated speech recognition (ASR) are located by the device on the other device (block 404). The position-determining device 104, for instance, may determine that the wireless phone 214 includes an address book 212. The phrases are then imported from the other device to the device (block 406), thus “sharing” the address book 212 of the wireless phone 214 with the position-determining device 104.

A context is generated to include one or more of the imported phrases (block 408). The context 208, for instance, may be generated to include names and addresses (e.g., street, city and state names) taken from the address book 212. For example, the context module 206 may import an abbreviation “KS” and provide the word “Kansas” in the context 208 and/or the abbreviation “KS”.

An audio input is translated by the device using one or more of the phrases from the context (block 410). The position-determining device 104, for instance, may determine that the user has selected an option on the position-determining device 104 to interact with the wireless phone 214. Accordingly, the context 208 created to help define phone interaction is fetched, e.g., located in and loaded from memory 118. The speech engine 204 may then use the context 208, and more particularly phrases 210(w) within the context 208, to translate an audio input from the user 128 to determine “meaning” of the audio input, such as text, a numerical representation, and so on.

The translated audio input may then be used for a variety of purposes, such as to initiate one or more functions of the other device based on the translated audio input (block 412). Continuing with the previous example, the position-determining device 104 may receive an audio input that requests the dialing of a particular phone number. This audio input may then be translated using the context, such as to locate a particular name of an addressee in the phone book. This name may then be used by the portable-navigation device 104 to cause the wireless phone 214 to dial the number. Communication may then be performed between the user 128 and the position-determining device 104 to leverage the functionality of the wireless phone 214. A variety of other examples are also contemplated.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
determining which data received by a position-determining device is selectable to initiate one or more functions of the position-determining device, wherein at least one said function relates to position-determining functionality;
generating a dynamic context to include one or more phrases taken from the data based on the determining; and
translating an audio input by the position-determining device using one or more said phrases from the dynamic context.

2. A method as described in claim 1, wherein the generating is performed dynamically to add one or more phrases in the context when added to a user interface of the position-determining device.

3. A method as described in claim 1, wherein the generating is performed dynamically to remove one or more of the phrases from the context when removed from a user interface of the position-determining device.

4. A method as described in claim 1, further comprising:
receiving data including the phrases; and
determining that the phrases are selectable to initiate the one or more functions of the position-determining device such that at least one phrase that is included in the data but is not selectable is not included in the generated dynamic context.

5. A method as described in claim 4, wherein the data is received by the position-determining device via a signal transmitted by a satellite.

6. A method as described in claim 4, wherein the data is received by the position-determining device via an Internet.

7. A method as described in claim 4, wherein the data is imported by the position-determining device over a local wireless network connection.

8. A method as described in claim 7, wherein the data is imported from a wireless phone.

9. A method as described in claim 1, further comprising:
receiving an input specifying a geographic location; and
obtaining automated speech recognition (ASR) data related to the geographic location; and
including the obtained ASR data in the context such that the translating of the audio input is performed at least in part using the obtained ASR data in the context.

10. A method comprising:
generating a context to include one or more phrases imported by a position-determining device from another device over a local network connection;
translating an audio input by the position-determining device using one or more said phrases from the context; and
performing one or more functions using the translated audio input that relate to position-determining functionality of the position-determining device.

11. A method as described in claim 10, wherein the other device is configured as a wireless phone.

12. A method as described in claim 10, wherein at least one of the functions is initiated by the position-determining device and performed by the other device.

13. A method as described in claim 10, wherein:
at least one of the phrases supplies a part of an address; and
the one or more functions include finding directions to the address from another address.

14. A method as described in claim 13, wherein the other address is a current position of the position-determining device determined using the position-determining functionality of the device.

15. One or more computer-readable media comprising instructions that are executable on a position-determining device to translate an audio input based at least in part on a context having phrases that are:
output to be displayed by the device; and
selectable to initiate one or more functions of the position-determining device that relate to position-determining functionality.

16. One or more computer-readable media as described in claim 15, wherein at least one other function includes initiating playback of musical content.

17. One or more computer-readable media as described in claim 15, wherein at least one other function includes selecting a broadcast channel.

18. One or more computer-readable media as described in claim 15, wherein the one or more functions include specifying a geographic location.

19. A position-determining device comprising one or more modules to translate an audio input using a context having one or more phrases taken from automated speech recognition (ASR) data, wherein the context is dynamic such that the phrases are added or removed from the context to correspond with phrases that are selectable to initiate a function of the position-determining device related to position-determining functionality.

20. A device as described in claim 19, wherein the one or more modules are further configured to:
receive data including the phrases to be displayed in a user interface; and
determine that the phrases are selectable in the user interface to initiate a function of the device such that at least one word that is included in the user interface but is not selectable is not included in the generated context.

21. A device as described in claim 19, wherein the one or more modules are further configured to:
receive an input specifying a geographic location; and
obtain the automated speech recognition (ASR) data related to the geographic location, wherein the translating of the audio input is performed using the ASR data in the context.

22. A device as described in claim 19, wherein the one or more modules are further configured to employ position-determining functionality.

23. A device as described in claim 19, wherein the one or more modules are further configured to employ music-playing functionality.
